(19) United States
(12) Patent Application Publication
(10) Pub. No.: US 2023/0249116 A1
(43) Pub. Date: Aug. 10, 2023

(54) SYSTEMS AND FILTER DEVICE FOR CONTROLLING AIR-SUSPENDED PARTICLE DISTRIBUTION AND CONCENTRATION

(71) Applicant: NANOCLEANAIR GMBH, Niederrohrdorf (CH)

(72) Inventors: Andreas MAYER, Niederrohrdorf (CH); Jan CZERWINSKI, Port (CH); Heinz BURTSCHER, Rudolfstetten (CH); Markus KASPER, Rudolfstetten (CH); Rainer MAYER, Ehrendingen (CH); Jörg MAYER, Niederlenz (CH)

(21) Appl. No.: 18/004,814

(22) PCT Filed: Jul. 6, 2021
(86) PCT No.: PCT/EP2021/068635

§ 371 Date: Jan. 9, 2023

(30) Foreign Application Priority Data
Jul. 8, 2020 (EP) 20184727.4

(51) Int. Cl. B01D 46/52; F24F 8/108; F24F 3/163

(52) U.S. Cl. CPC B01D 46/52; F24F 8/108; F24F 3/163; B01D 2273/30

(57) ABSTRACT

A system for air decontamination in a three-dimensional space described herein includes an air inlet for drawing in air, an air outlet for administering filtered air, and a filter device for filtering air prior to administration through the air outlet, the system is configured to draw air in a substantially vertical laminar flow from a ground of the space to the air inlet. A filter device for filtering ultrafine particles from a gas described herein includes a first filter medium for absorbing polar liquids but not ultrafine particles; in fluid communication with a second filter medium for absorbing ultrafine particles; and a gas outlet, the first filter medium is configured to allow vaporization of the absorbed polar liquids; the device is configured to guide the gas from the first to the second filter medium and through the second filter medium; and the second filter medium forms the gas outlet.

### CROSS-REFERENCE TO RELATED APPLICATIONS

The present application is a National Stage Entry of PCT/EP2021/068635, filed 6 Jul. 2021, published as WO 2022/008500 A1, which claims the benefit of and priority to European Patent Application Serial Number 20184727.4, filed: 8 Jul. 2020, each of which are incorporated herein by reference in its entirety.

### FIELD OF THE INVENTION

The present invention is directed to a system for air decontamination in a three-dimensional space comprising an air inlet for drawing in air, an air outlet for administering filtered and optionally fresh air and a filter device for filtering air prior to administration through the air outlet, wherein the system is configured to draw air in a substantially vertical laminar flow from a ground of the space to the air inlet. The invention further pertains to a filter device for filtering ultrafine particles from a gas comprising a first filter medium for absorbing polar liquids but not ultrafine particles; in fluid communication with a second filter medium for absorbing ultrafine particles; and a gas outlet, wherein the first filter medium is configured to allow vaporization of the absorbed polar liquids; the device is configured to guide the gas from the first to the second filter medium and through the second filter medium; and the second filter medium forms the gas outlet.

### BACKGROUND

Ultrafine particles, also called nanoparticles, significantly add to air pollution and depending on their nature constitute a health hazard for humans and animals. The particles can be linked to a range of diseases, such as heart attacks, cancer, lung disease, and immune system diseases partly because ultrafine particles readily pass into body cells and are distributed systemically. Apart from toxic effects, infections may also be caused by ultrafine particles such as viruses. Many ultrafine particles, especially viruses, have in common that they remain in a floating state in ambient air with a remarkably slow rate of decent (approx. 10 cm/h for viruses) and remain infective while floating in ambient air over a period of about 3 to 5 hours. The health risk for humans and animals being exposed to ultrafine particles in ambient air is increased by prolonged exposure times while standard means of protection such as face masks or distancing do not sufficiently reduce the health risk due to the small size of the particles and the long floating time as well as extensive distribution of the particles in the air by diffusion, turbulence and/or active ventilation.

Conventional ventilation systems such as air conditioning systems in closed spaces may even increase the health risk caused by ultrafine particles because these systems distribute the particles from the source to the whole space. Also, most ventilation and/or air conditioning systems introduce air from the ceiling downwards which (also in combination with air recirculation) leads to the distribution of particles, e.g. viruses, around the people in the closed space.

The effective filtering of ultrafine particles in closed spaces faces several challenges. The filters required for ultrafine particles can only cope with a slow air flow and the turn-around of large volumes of air for effective reduction of the particle concentration is limited by the air speed through the filter. To increase the turn-around, the filter surface area would have to be increased which is not always feasible or economical. This problem is exacerbated by contamination of the filters. This contamination can be the result of, e.g., liquids which condense on the filter material and thereby block the filter, i.e. significantly and adversely increase the flow resistance of the filter. Even worse, condensed water in the filter can lead to bacterial or fungal growth and often results in washing out of filtered ultrafine particles which are then re-administered to the previously filtered air. Additionally, larger particles such as dust, pollen, coarse aerosols and bacteria, e.g. having mean diameters of more than 500 nm, can block ultrafine particle filters. If larger particles cover the ultrafine particle filter's surface, this coverage also significantly reduces any functional coatings on the filter, e.g. any anti-microbial or anti-viral coatings.

Protective shields such as masks or visors only prevent that particles emitted by an infected person, e.g. by sneezing or coughing or just normal exhalation, are directly transmitted from the infected person to another person close to the infected person. However, aerosols of, e.g. viral particles, remain suspended in air for long periods, e.g. 3 to 5 hours. The aforementioned shields cannot avoid the diffusion of the emitted particles in ambient air which results in contamination of large volumes of air and potential transmission of the particles, e.g. viruses, to other people. Air filter systems for ultrafine particles such as viruses, on the other hand, are generally limited by the (small) volume of air they can effectively clean.

It is further noted that for some infectious particles, e.g. viruses, a very small concentration in the air is sufficient for infecting people. Common methods for reducing the infection risk in enclosed spaces include opening windows, running ceiling fans and installing local filters which filter the air and randomly expel filtered air into the enclosed space. All these methods share the drawback that the contaminated air in the enclosed space is not effectively removed before it comes into contact with people, but is rather distributed within the closed space with the goal of reducing the particle concentration.

### SUMMARY

In a first aspect, the present invention is directed to a system for air decontamination in a three-dimensional (3D) space, optionally a closed 3D space, the system comprising
(I) at least one air inlet positioned essentially at a top of the 3D space and configured to draw in air from the 3D space,
(II) at least one air outlet, optionally positioned essentially at a ground of the 3D space, and configured to administer filtered and optionally fresh air to the 3D space,
(III) a filter device, optionally a filter device as described herein, in fluid communication with the at least one air inlet and outlet, configured to filter ultrafine particles from the air drawn in through the air inlet and optionally from fresh air, and configured to at least partially exhaust the filtered air through the air outlet,
   wherein the system is configured to draw air in a substantially vertical laminar flow substantially from a ground of the 3D space, optionally from the air outlet, into the air inlet.

It was surprisingly found that a substantially vertical laminar flow, i.e. a relatively slow and turbulence-free air flow, effectively channels particle-contaminated air up and away from a person in a three-dimensional (3D) space. This laminar flow essentially leads to a stratification of the air (forming layers) in a room of which at least the top layer is prevented from lateral or vertical movement, and is removed through the air inlets. The term “laminar flow” as used herein is understood as commonly known in the art, i.e. referring to gas particles following smooth paths in layers, with each layer moving smoothly past the adjacent layers with little or no mixing. The laminar upwards flow is supported by the natural thermal effect, e.g. the convective flow of air, around people who naturally radiate body heat (or around other warm objects). The term “substantially vertical laminar flow” as used herein is alternatively termed “3D air-uplift zone” or “uplift zone”. These terms essentially have the same meaning as they refer to the laminar upwards flow of air. Also, the flow can be considered a curtain of airflow depending on the application and the air speeds chosen.

It is noted that the substantially vertical laminar flow is not primarily the result of or caused by the air exiting the air outlet(s). In other words, the air outlets are not necessarily arranged such that they actively “blow” air upwards to cause a laminar flow towards the air inlets. In other words, the air outlets do not need to be positioned opposite the air inlets (in vertical direction) but can be positioned anywhere as long as their position allows for a substantially vertical laminar flow to occur towards the air inlets, e.g. around a person within the 3D space. Optionally the air outlets are positioned in the lower part of the 3D space (the lower part being synonymous with the ground of the 3D space as defined herein).

The substantially vertical laminar flow is essentially caused by the natural propensity of air to flow upwards, in particular if the air is heated, e.g. by the presence of persons or objects which emit heat via their surfaces (body, face for persons) or their breath, or by actively heating the air admitted to the 3D space or heating surfaces within the 3D space. The natural body heat of persons (about 100 watt per person), the addition of heat to objects or the heating of the air admitted to the 3D space (e.g. 3 to 30° C., 5 to 20° C., optionally 3 to 10° C. or about 10° C. above room temperature) leads to a thermally assisted substantially vertical laminar flow towards the air inlets. Generally, a person breathes out air at about 37° C. Hence, the contaminated air emitted from a person is already heated and has the propensity to flow upwards. Therefore, the air outlets are not necessarily positioned such as to create a 3D space or the 3D air-uplift zone. They may be placed outside the uplift zone and the laminar flow will still occur towards the air inlets.

The term “ground of the 3D space” or “substantially from the ground of the 3D space” as used herein refers to a position below an origin of contamination, e.g. a person's head or any other source of contamination and means that the substantially vertical laminar flow occurs from below this origin of contamination to move the contamination upwards into the air inlets. The relative position below an origin of contamination, e.g. a person's head is herein termed the lower part, the bottom part or the ground of the 3D space. Optionally, the ground of the 3D space is the actual ground of a 3D space, e.g. the floor of a room. The term “substantially” in the context of the vertical laminar flow and from the ground includes that the, e.g. initial, flow of the air, e.g. at or near the ground, may include non-vertical, e.g. horizontal, components which develop into the substantially vertical flow. The term, however, means that the majority of the laminar flow occurs in vertical direction. The term further means that the laminar flow originates at or in close proximity from a ground which means that it does not necessarily originate exactly at the ground.

The system described herein also protects the environment from a person infected with a microorganism or virus, herein called “infected person”. When an infected person emits particles, e.g. viral particles, these are drawn upwards and away from other people by the laminar flow created by the system described herein. The present system and the laminar flow in particular avoid turbulences which can cause a, e.g., lateral distribution of emitted particles and subsequent infections of people in the 3D space.

As an alternative to filtering the complete volume of a given enclosure or 3D space, the air in the local environment around an infected person can be cleaned by the system and/or device described herein. For this purpose, a three-dimensional (3D) space around an infected person is defined, for which space the air is to be cleaned.

In an embodiment, the system according to the present invention is one, wherein the 3D space is a closed indoor space, the at least one air inlet is positioned essentially above a height of a standing or sitting person or essentially at a ceiling of the space, and the at least one air outlet is positioned essentially below the height of the standing or sitting person or on the ground of the 3D space, optionally on or below a floor of the space.

The 3D space, as used herein, can be any space which may or may not be enclosed, e.g. it may be fully or partially enclosed, e.g. by walls, curtains or other enclosing means. Optionally the 3D space comprises at least one person. Exemplary 3D spaces include rooms, classrooms, restaurants, hospital rooms, offices, spaces around people in hospital beds, on airplane seats, on bus seats or work places. The 3D space may be further segmented into partial 3D spaces by defining specific suction/ventilation zones and/or further structural means such as, e.g., walls, curtains or shields. Alternatively, the (partial) 3D space may be characterized by the presence of a person or an object emitting heat, by heating the admitted air into the 3D space or by heating objects or surfaces in the 3D space (about 3 to 30° C., 5 to 20° C., optionally 3 to 10° C. or about 10° C. above the actual room temperature) which heat, optionally together with the position of the air inlets, creates the substantially vertical laminar flow upwards and thus defines the 3D space or the uplift zone. The 3D space can also be defined by directing an air flow.

In an embodiment, the system according to the present invention is one, wherein the 3D space is a space formed around a person and is optionally further defined by structural means, optionally walls, curtains or shields.

In an embodiment, the system according to the present invention is one, wherein the 3D space is a space formed around a person standing or sitting in a room, or around a person, optionally around a person's head, lying on a bed.

The air inlet of the present system is essentially positioned at a top of the 3D space which means that it is positioned at least high enough to be above the height of a sitting, lying and/or standing person in a 3D space. In other words, the air inlet is positioned such that it will be above the highest point of a person occupying the 3D space.

The air inlet may be of any shape suitable for drawing in air. Exemplary shapes include funnels, cones, dishes, or straight pipes. An exemplary cone shape can have the following dimensions: cone angle of about 90°, an entry diameter (air inlet) of about 1 m and an exit diameter (from the air inlet to the piping) of about 0.1 m. The air inlet may be connected to or comprise a perforated member as described below.

The air outlet is positioned such that the air flows in a laminar flow substantially from a ground of the 3D space, in other words, the air outlet(s) is(are) positioned in the system such that its/their position together with the speed of the air exiting the air outlet allow for and optionally support the substantially vertical laminar flow substantially from a ground of the 3D space into the air inlets. However, and as outlined above, the air outlets are not necessarily arranged such that they actively “blow” air upwards to cause a laminar flow towards the air inlets. The air may also be admitted through the air outlets in a horizontal direction or at any angle between horizontal and vertical. Also, the air outlets may be positioned anywhere in the 3D space as long as their position allows for a substantially vertical laminar flow to occur towards the air inlets. Optionally, the air outlets are positioned in the lower or bottom part of the 3D space (as defined herein). The air outlet may be positioned in a wall or object of the 3D space, form or be integrated into the floor of the 3D space, e.g. in a skirting board, a seating or bed surface, an arm rest, a chair, a desk, a bed or any other structure that is substantially below a person's head. It is noted that one of the air outlets functions is to compensate the volume loss caused by the air draw through the air inlets. Hence, the positioning of the air outlets should be such that, e.g., there is essentially no vacuum and/or associated turbulences (disturbing the laminar flow and causing potential contamination with particles) near or at the bottom part of the 3D space.

Fresh air, as used herein, refers to, e.g., air drawn in from outside the 3D space, which, e.g., comprises sufficient oxygen for people in the 3D space. The fresh air is optionally not contaminated with bacteria or viruses and it is preferred that the fresh air is passed through the filter device before being admitted into the 3D space to remove ultrafine particles, as well as contaminants such as dust, pollen, coarse aerosols and bacteria. As an alternative to fresh air, CO2 may be removed from the air administered to the 3D space and/or oxygen may be introduced into the air that is administered to the 3D space.

The system of the present invention is configured such that the substantially vertical laminar flow starts substantially from a ground of the 3D space. However, the present invention includes systems in which the flow starts at least from or below the head of a person occupying the 3D space.

For example, the laminar air flow is fed from the air outlet which provides filtered and optionally fresh air.

The filter device described in the context of the present system may be any filter capable of filtering at least ultrafine particles from air, and may, for example, be a filter device as described below.

Filtered air, as used herein, means that the air is filtered from at least ultrafine particles, i.e. particles of a mean diameter size of 10 to 500 nm, in particular 30 to 200 nm. Optionally the air comprises less than about 200 ppm ultrafine particles per I of air after being filtered (after passing the filter device). Additionally, larger particles such as dust, pollen, coarse aerosols and bacteria, e.g. having mean diameters of more than 1 μm or 500 nm can be, optionally, filtered.

The system is configured such that at least part of the filtered air is exhausted into the 3D space, which leads to a recirculation of the filtered air and a continuous, cyclic reduction in contamination of the air through every filtering cycle. Additionally, part of the filtered air may be exhausted into the exterior of the 3D space.

In an embodiment, the system according to the present invention is one, wherein the substantially vertical laminar flow has an average speed of about 0.1 to 0.2 m/s, optionally 0.02 to 0.4 m/s or 0.05 to 0.4 m/s.

The speed of the vertical laminar flow is understood as the mean or average speed the air flow has in the 3D space.

In an embodiment, the system according to the present invention is one, wherein the system is configured to exchange the volume of the 3D space between 2 to 6, optionally between 3 to 5, optionally about 4 times per hour.

For other, e.g. smaller, 3D spaces and, e.g. for hospital rooms, aircraft or other transportation environments, the system can be configured to exchange the volume of the 3D space at more than 10 to 20 times per hour.

In an embodiment, the system according to the present invention is one, wherein the system is configured to have an average air speed of about 0.1 to 0.2 m/s, optionally about 0.05 to 0.2 m/s, optionally about 0.1 m/s at the at least one air inlet.

The average air speed at the at least one air inlet is measured at the cross section of the air inlet where the air enters.

In an embodiment, the system according to the present invention is one, wherein the system is configured to have an average air speed of about 0.01 to 0.2 m/s, optionally about 0.05 to 0.15 m/s at the at least one air outlet.

The average air speed at the at least one air outlet refers to the speed of the air when it leaves the air outlet and enters the 3D space. The air speed within the at least one air outlet may be higher than the speed of the air leaving the air outlet. For example, means can be installed for reducing the air speed at the interface between the air outlet and the 3D space, e.g. as described below.

In an embodiment, the system according to the present invention is one, wherein the at least one air inlet comprises a perforated member at least partially covering one or more air inlet(s) and having openings through which the air is drawn from the 3D space, and optionally further comprises sealing means for sealing one or more openings against air.

The perforated member refers to a structural element that comprises air tight sections as well as openings which allow air to flow from the 3D space into the air inlet. The perforated member can be made from materials known in the art, e.g. from textiles, plastics, plastic foams or porous ceramics. For example, the perforated member may have a larger surface compared to the cross section of the air inlet. Also, some of the openings of the perforated member may be closed by suitable means, e.g. by sealing means which can be placed such as to create areas of active suction, e.g. above people. Alternatively, the sealing means may constitute areas of the perforated members which do not comprise openings. For example, the perforated member may form a sealing of a 3D space, e.g. a perforated ceiling to which the air inlet(s) are connected. Specific suction zones in the ceiling may be created, e.g. by suitably positioning the air inlets, the openings and/or the sealing means. The perforated member can, e.g., create an essentially horizontal and/or optionally essentially flat plane (e.g. a ceiling) at which the air is drawn through the openings into the air inlets. This horizontal plane has the advantage that no hidden areas are created in which the up-flowing air is not drawn into the air inlets, e.g. hidden areas above a cone-shaped air inlet. Thereby, the air can be drawn through the perforated member homogeneously over the whole surface of the perforated member. In an embodiment, the perforated member or ceiling may span substantially the whole top of the 3D space and it may be positioned below the structural ceiling/roof of the 3D space, e.g. taking the shape of an acoustic ceiling with perforations which form openings for air and concomitantly reduce acoustic pressure levels. Alternatively, the perforated member may be part of or form the (structural) ceiling of the 3D space.

Generally, the air inlet(s) and/or the air outlet(s) may be positioned such that specific suction zones and ventilation zones are created, e.g. according to the location of people in a 3D space. Typical sizes for the suction zones in the perforated member or ceiling range from 0.3 to 1 m².

In an embodiment, the system according to the present invention is one, wherein a cross section of the at least one air inlet is about the same or larger than the sum of the cross sections of the openings in the perforated member.

For achieving a uniform air suction across the perforated member, it is beneficial that the cross section of the air inlet, e.g. the tube which forms the air inlet, is about the same or larger than the sum of the cross sections of the openings in the perforated member. Alternatively or additionally, the area of the perforated member directly below the air inlet, e.g. the air inlet tube, can be sealed by not comprising openings or it can be blocked by the sealing means.

In an embodiment, the system according to the present invention is one, wherein the perforated member forms a ceiling of the 3D space and optionally wherein a ratio between a sum of a surface defined by the openings and a total surface of the perforated member is about 1:1 to 1:30, optionally about 1:2 to 1:20, optionally about 1:3 to 1:10.

In other words, and with reference to the figures for clarity only, the sum of all distances (112) within the total surface (114) is compared to the total surface (114) of the perforated member, as illustrated in the figures below.

The membrane is installed such that the air leaving the air outlet passes through the membrane and loses velocity.

In an embodiment, the system according to the present invention is one, wherein the at least one air outlet comprises a porous membrane through which the filtered and optionally fresh air is administered to the 3D space.

The term “porous membrane”, as used herein, refers to any mono-or multi-layered structure that is permeable to air and optionally reduces the velocity of the air passing through the membrane upon administration to the 3D space. The pores of the membrane can be of any size, shape and number as long as they allow air to pass such that the substantially laminar flow in the system is supported, e.g. by admitting air in an essentially turbulence-free and/or laminar flow. The membrane may comprise one or more layers of one or different materials, e.g. to achieve sufficient structural stability to withstand the pressure difference between the inside (air outlet) and the outside (3D space), to reduce the air velocity, and/or to form structural parts of the 3D space such as the floor or parts of furniture.

The air outlets of the present system are preferably configured such (e.g. by features described herein) that the laminar flow of the air is already initiated when the air exits the air outlet, i.e. the air leaves the air outlets as a laminar flow.

In an embodiment, the system according to the present invention is one, wherein the porous membrane is configured to reduce a velocity of the filtered and optionally fresh air upon administration to the 3D space by a factor of about 50 to 200, optionally by a factor of about 50 to 100.

For example, the reduction of air velocity through the membrane is achieved by suitable choice of the pore size. A small pore size will generally necessitate a higher porosity. Also, the pressure loss across the membrane and the surface area of the membrane can be chosen to achieve the suitable air velocity. For example, a large surface area of the membrane can decrease the velocity of the air while the concomitant pressure loss is relatively small. The skilled person can adjust the aforementioned parameters in order to achieve the desired reduction in air velocity and the final speed of the air exiting the air outlet.

In an embodiment, the system according to the present invention is one, wherein the porous membrane has
(a) a porosity of about 40 to 90%, optionally about 60 to 80%;
(b) a pore size of about 0.01 to 1 mm, optionally about 0.05 to 0.5 mm;
(c) a thickness of about 0.1 to 2 mm, optionally about 0.2 to 1 mm; and/or
(d) a density of about 100 to 200 g/m².

The term “density” in the context of the porous membrane is used interchangeably with the terms “grammage” or “surface weight”.

Suitable materials for the membrane are known in the art. Membranes with sufficient stability include, e.g. sieve or screen cloths/fabrics or mesh laminates which are typically used in the context of sieves or in the filter industry (e.g. as provided by PACO Paul GmbH & Co. KG Metallgewebe and Filterfabriken, Steinau, Germany). Depending on the application, the membrane can comprise a structural support layer such as, e.g., a perforated (metal) plate. Such a structural support layer may form the floor of a 3D space. For example, the structural support layer (also) supports and provides structural stability to the porous membrane, e.g. the cloth or fabric, and is positioned on the interior side of the membrane, i.e. towards the air inlet, whereas the further components of the porous membrane, e.g. the cloth or fabric, are positioned on the exterior side, i.e. facing the 3D space. For example, the positioning of the support layer ensures that the support layer itself does not critically affect the air velocity of the air passing through the porous membrane. In other words, the support layer is preferably constructed and positioned such that it does not significantly increase the velocity of the air exiting the air outlets. This construction and positioning should support the substantially laminar flow, e.g. by allowing the air to be admitted into the 3D space in an essentially turbulence-free and/or laminar flow.

Exemplary perforated plates may have openings of about 10 mm in diameter, can be spaced about 5 cm apart and can be covered by a fabric or cloth, e.g. a carpet or cotton cloth with a density of, e.g., about 100-200 g/m². This fabric or cloth again reduces the air velocity to the desired range while also forming the floor cover. Both, the structural support layer and the fabric or cloth are together considered the porous membrane as disclosed herein. Additionally, the fabric or cloth may be protected by a further structure, also encompassed by the porous membrane disclosed herein. This further structure may be a lattice-like or mesh-like, e.g. metal or plastic structure.

The porous membrane may also comprise a foam (body) that is optionally covered by a further layer with sufficient stability as described above, e.g. a sieve or screen cloth/fabric or mesh laminate. Alternatives to the foam include a semi-rigid porous structure such as 3D-spacer fabrics used for cushions or mattresses, e.g. if the air outlet including the porous membrane constitutes a cushion of a seat or mattress of a bed. It is noted that when foams are used, it is advantageous that the porosity of the foam is higher than that of the further layer with sufficient stability as described above to ensure a uniform air flow across the air outlet.

In an embodiment, the system according to the present invention is one, wherein the porous membrane comprises or is made of a fabric, a cloth, a wire mesh, a foam, optionally a polymer foam, a polyurethane foam, a perforated plate, optionally a perforated metal plate, or a combination thereof.

In an embodiment, the system according to the present invention is one, wherein the system further comprises at least one of: a device for moving gas, at least one device for regulating the ratio of fresh and filtered air, a CO₂-measuring device, and a heat exchanger configured to exchange heat between filtered and fresh air.

The device for moving gas, optionally a radial blower or a fan, is configured to move the gas through the device. For example, a radial blower can be used, e.g. with steep pressure characteristics, e.g. a radial blower that provides a pressure level of up to about 25 mbar. For example, the device for moving gas can be positioned before the filter and can push gas onto the filter while drawing air from the air inlet(s) and optionally from a fresh air source.

The device for regulating the ratio of fresh and filtered air may be, e.g., a valve that regulates the amount of fresh air admitted into the 3D space, and/or regulates the amount of air that is exhausted out of the 3D space, either after or before it is passed through the filter. Fresh air may be admitted into the 3D space after it passed the filter in order to remove ultrafine particles and/or larger particles such as dust, pollen, coarse aerosols and bacteria. The amount of fresh air may be determined by monitoring the CO₂-levels in the 3D space, e.g. by the CO₂-measuring device which measures the CO₂-levels either directly in the 3D space or in the air drawn in through the air inlets.

A heat exchanger may be installed configured to exchange heat between filtered and fresh air. Alternatively, the heat exchanger may exchange heat between fresh air and air that is drawn in through the air inlets and/or exhausted from the 3D space. The heat exchange can be a heat transfer from the exhausted to the filtered and/or fresh air or a cooling of the fresh or filtered air. Also, the heat exchanger may constitute the means for thermally supporting and/or increasing the substantially vertical laminar flow as outlined below.

In an embodiment, the system according to the present invention is one, wherein the system further comprises means for thermally supporting and/or increasing the substantially vertical laminar flow, optionally means for warming the filtered and optionally fresh air prior to, during or after administration to the 3D space.

The substantially vertical laminar flow in the 3D space can be supported or increased by introducing heat, e.g. by heating the air that is admitted through the air outlet. The air may be heated prior to exiting the air outlet, e.g. by the heat exchanger or other suitable means. Due to the laminar flow of the air in the 3D space, it is believed that the heat loss is minimal and that there is little to no heat transfer onto persons or objects within the 3D space. Additionally or alternatively, local hotspots in the 3D space may be created to thermally support the substantially vertical laminar flow. These hotspots may be created on surfaces within the substantially vertical laminar flow, e.g. by heating the floor or objects (e.g. desks, chairs, or their edges) e.g. by 1 to 5° C. Heating may be achieved, e.g. by irradiation of the floor or objects (e.g. sun light, laser or infrared irradiation) or by local heat emitters (radiators).

In an embodiment, the system according to the present invention is one, wherein the means for warming the filtered and optionally fresh air warm the air by about 5 to 20° C., optionally by about 10° C. above the temperature in the 3D space.

The temperature in the 3D space is the ambient temperature of that space, e.g. room, e.g. room temperature.

In an embodiment, the system according to the present invention is one, wherein the filter device (200) is a filter device as described herein.

Specific and exemplary systems according to the present invention will be described below in greater detail.

In another embodiment, the present invention is directed to a system for isolating a person comprising a filter device, e.g. as described herein, a device for moving gas as described herein and an air inlet in fluid communication with the filter device, wherein the air inlet, optionally the filter device and/or the device for moving gas, is positioned above or below a person and the system is configured to draw air from around the person in a substantially vertical direction into the air inlet to prevent exhaled air of the person from diffusing into and mixing with ambient air.

The air inlet, the filter device and the device for moving gas of the present system are all in fluid communication with each other, e.g. from the air inlet through the device for moving gas to the filter device. At least the air inlet is positioned above the person to be isolated while the filter device and the device for moving gas can be positioned at any suitable location as long as the air drawn in through the air inlet is passed, guided or forced through the filter device, e.g. via tubing or piping.

For example, the air surrounding an infected person can be, e.g. essentially vertically, sucked off into the filter device thus defining a 3D space around the infected person for which the air is filtered. The air flow, e.g. from the ground up to the air inlet of the filter device above the infected person, creates a 3D air-uplift zone (termed “uplift zone” zone in the following) around the infected person that avoids that the exhaled air of the infected person diffuses into and mixes with the ambient air outside of the uplift zone (see, e.g., FIG. 5). Preventing the exhaled air from mixing with the ambient air leads to the isolation of a person as described in the present embodiments.

The limited volume of the 3D space in the uplift zone created around the infected person can be filtered by a filter device that is much smaller and more economical compared to a filter device that would be needed to filter the complete ambient air of the infected person's environment, e.g. the room or building the infected person is in. Additionally, the definition of the 3D space around the infected person by the uplift zone allows the person to move freely as long as the uplift zone is maintained around the infected person.

The velocity of the air creating the uplift zone around the infected person may be sufficiently high to substantially reduce or avoid diffusion of exhaled air from the inside to the outside of the 3D space created by the uplift zone. For example, the air speed in the uplift zone can be in the range of about 0.1 to 0.2 m/s.

In another embodiment, the system described herein is one, wherein the device is configured to exhaust at least a part of the drawn and filtered air in direction of the person such that the exhausted air is recirculated into the device. For example, the filter device may have an air outlet that directs at least part of the filtered and exhausted air into the uplift zone such that at least part of this exhausted air is again drawn into the air intake of the system.

For example, an uplift zone can be created by positioning a suction hood as the air intake above a person, e.g. a person in a chair, wheelchair, a bed, a car, bus, train, ferry or aircraft seat, e.g. as a system for isolating a person described herein. The suction device may be any device for moving a gas as defined herein. To support the isolating effect of the uplift zone, structural barriers such as visors, shields or masks can be positioned in front of an infected person's head or mouth and nose to prevent that particles emitted at high velocities (e.g. by sneezing or coughing) penetrate the uplift zone. Optionally, a filter device, e.g. as described herein, can be used to clean the air within a protective suit or helmet by filtering the air within the suit or helmet.

Instead of creating an uplift zone by sucking air from above an infected person and into a filter device, a three-dimensional (3D) space around an infected person can also be created by sucking in air substantially below a person's head (creating a “drag zone”). For example, air can be sucked in through an opening in a table, e.g. a dining table, in a counter in front of a person, e.g. a cashier, or in an opening in the floor. The same principles, features and embodiments described herein for the uplift zone and the system for isolating a person also apply for the drag zone and both zones can be used in all embodiments and examples described herein. The main difference to the system with the inlet above a person is that the inlet is now below the person, optionally at least below the head, breast, waist, hip, knees, or feet and that the gas to be filtered moves substantially vertically down into the inlet.

Alternatively, an air shield or a curtain of airflow can be created in between two or more people or around a person. The air shield is meant to be encompassed in the term “curtain of airflow”. The curtain of airflow may be created as described herein for the uplift or drag zone or by blowing air to create the curtain, and, e.g. which blown air is sucked in by a filter device as described herein.

In another embodiment the system of the invention is configured for isolating at least two people comprising a filter device of the invention, a device for moving gas and an air inlet in fluid communication with the filter device, wherein the air inlet forms part of a ceiling, a floor or of a piece of furniture, optionally a table, counter, bar, desk, hood, seating device, e.g. bench, chair, sofa, wherein the air inlet is positioned above or below the at least two people to create a substantially vertical air curtain between the at least two people, the system optionally further comprising an air outlet providing filtered air from the air inlet and positioned substantially opposite the air inlet.

For example, the curtain of airflow can be created by blowing air towards an air intake, which air intake may in turn create an uplift or drag zone and administer the air to a filter device. Optionally, a diameter of the air exit of the device blowing air for the curtain of airflow is selected to be about 50% of the diameter of the air inlet of the device sucking in the blown-out air. For example, the air speed of the curtain of airflow may be in the range of about 0.5 to 5, or about 1 m/s.

For effectively creating an uplift or drag zone or a curtain of airflow and filtering the airflow, the suction or blowing power should be adjusted to the size of the 3D space, the distance between air inlet and outlet and environmental impacts such as wind or other air streams. For example, an increased airflow is required, if the uplift or drag zone or the curtain of airflow should alone be capable of preventing particles of high velocity, e.g. emitted by sneezing or coughing, from penetrating the 3D space.

The air that is sucked into the filter device can either be exhausted into the environment or it can be exhausted such that it is sucked into the filter device again, creating a recirculation. The recirculation has the advantage that with every cycle of recirculation, the concentration of ultrafine particles is reduced, e.g. reducing the required size and capacity of the ultrafine particle filter.

It is a further objective of the present invention to provide improved filter means for filtering ultrafine particles from a gas, as well as to provide systems to reduce the concentration of ultrafine particles in a gas, in particular in ambient air.

In a first aspect, the present invention is directed to a filter device for filtering ultrafine particles from a gas, optionally a gas comprising polar liquids, comprising:
(i) a first filter medium for absorbing polar liquids, optionally water, and optionally particles of more than about 1 μm or 500 nm diameter; in fluid communication with
(ii) a second filter medium for absorbing ultrafine particles; and
(iii) a gas outlet;
wherein
   (a) the first filter medium is configured to allow vaporization of the absorbed polar liquids;
   (b) the device is configured to guide the gas from the first to the second filter medium and through the second filter medium; and
   (c) the second filter medium forms the gas outlet.

Gas, especially ambient air, often comprises liquid water in the form of, e.g., droplets. Conventional filter devices, in particular for ultrafine particles, may be hampered in their efficacy by these liquid water droplets which are absorbed by the filter medium of the devices. When water or any other polar liquid is absorbed by filters for ultrafine particles, the filters block—or even worse—release the previously filtered particles. This release is mediated by the polar liquid which engulfs or binds to the particles and carries them through the filter medium. In addition to polar liquids in the form of droplets, these liquids may be present in the gas, e.g. ambient air, in their gas form and condense on the filter medium when being moved through a filter device which also results in the aforementioned problems. Additionally, accumulated or condensed water in ultrafine particle filter media may form a basis for microbial or fungal growth which represents a nuisance (e.g. odor) or health hazard. Additionally, larger particles such as dust, pollen, coarse aerosols and bacteria, e.g. having mean diameters of more than 1 μm or 500 nm can be, optionally, filtered by the first filter medium. Alternatively, the filtering of these particles can be achieved by a further (e.g. third) filter medium as set forth below. These particles of more than 1 μm or 500 nm can block the second filter medium and significantly and adversely increase the flow resistance of the second filter medium. If larger particles cover the second filter medium's surface, this coverage also significantly reduces any functional coatings on the filter, e.g. any anti-microbial or anti-viral coatings.

The device of the present invention comprises a first filter medium for absorbing polar liquids and optionally particles of more than about 1 μm or 500 nm before these liquids and optionally the particles come into contact with the second filter medium for ultrafine particles. The first filter medium is of a composition which allows a gas, e.g. ambient air, and ultrafine particles (e.g. particles of less than about 1 μm or 500 nm diameter) to pass but retains polar liquids and optionally particles of more than about 1 μm or 500 nm on the surface or within the structure of the first filter medium. For example, the first filter medium is of a composition which is sufficiently porous for enlarging the surface area in favor of vaporization of the retained polar liquid, but sufficiently dense to avoid passage of the polar liquid and optionally particles of more than about 500 nm towards the second filter medium. Due to the stream of gas through the first filter medium and/or the composition of the first filter medium, the retained polar liquids vaporize and pass the second filter medium in their gas form. Vaporization may be enhanced by heating the passing gas and/or the first filter medium or by adjusting, e.g. decreasing, the air pressure on the outlet side of the first filter medium in order to reduce the boiling point of the polar liquid. For example, the first filter medium can be made of a material with water-absorbing properties due to a hydrophilic surface, e.g. a cellulose material or a material with hydrogel fibers, wherein water is first adsorbed, then absorbed and only released in gaseous form by diffusion.

The aforementioned polar liquids may also comprise particles, such as, e.g., viruses, and they may be suspended in a gas and enter the device of the present invention. The liquid-coated, in particular water-coated, viruses can emerge, e.g. from humans or animals who/which sequester virus-comprising droplets by coughing or sneezing but also by normal exhalation. The latter especially generates smaller aerosol droplets in the range of 5 μm that quickly, e.g. in milliseconds, or between 0.01 and 0.1 s, transform to a dry aerosol while coughing or sneezing generates larger droplets (0.1-1 mm) that are less likely to transform into an aerosol. If the water is not removed from the particles or viruses before they reach a filter for filtering ultrafine particles, the filter may be blocked and/or the water-coated virus may pass the filter as described in general above for polar liquids.

The first filter medium of the device of the present invention removes the liquid coating, in particular the water coating, from particles, e.g. viruses, and thus enables the filtration and retention of the substantially liquid-free ultrafine particles in the second filter medium.

Ultrafine particles, as used herein, are particles of a mean diameter size of 10 to 500 nm, in particular 30 to 200 nm. Examples for ultrafine particles include combustion generated particles like soot or metal oxides, abrasion and wear particles from breaks and tires, viruses and retroviruses, optionally corona viruses (70-150 nm), SARS, Influenza viruses, MERS, Measles, Ebola.

The first filter medium of the present device is in fluid communication with the second filter medium. This means that the device is configured such that the gas passes through the first filter medium and is then directed, guided or forced to pass through the second filter medium essentially without bypassing the second filter medium and/or without exiting the device before passing through the second filter medium.

The gas from which the ultrafine particles are filtered can be any gas including ambient air, recirculated air, pressurized air, or medicinal oxygen.

A polar liquid, as used herein, is defined as commonly understood in the art and includes polar liquids such as water.

In an embodiment, the first and/or second filter medium form at least part of a first and/or second filter housing.

For example, the first filter housing may have a gas inlet and at least part or all of the housing's walls can be made from the first filter medium. The gas to be filtered can enter the first filter housing via a gas inlet and pass through the first filter medium in direction of the second filter medium. Alternatively, the first filter housing's walls may be gas-impermeable and may be at least partially or fully covered on the inside of the filter housing with the first filter medium. In this case, for example, the first filter housing comprises a gas outlet in addition to the gas inlet in order for the gas to be filtered to flow in direction of the second filter medium.

The second filter housing may, for example, be entirely or partially made from the second filter medium. For example, the device can be constructed such that all the gas to be filtered which enters the device of the invention passes through the second filter medium before exiting the device. Alternatively, the second filter housing may have gas-impermeable walls and a gas outlet which encompasses the second filter medium, which corresponds, e.g., to an embodiment in which the second filter partially forms the second filter housing.

In a further embodiment, the first filter housing is configured to allow and/or create a rotational spin or turbulent flow of the gas for contacting the first filter medium.

For example, the rotational spin or turbulent flow of the gas results in the polar liquids to be deposited on the first filter medium which can form or be positioned on the first filter housing. The rotational spin or turbulent flow may be generated by the geometry of the first filter housing or by means comprised therein, e.g. by flow-directing means, e.g. vanes, or it may be generated by a suitable gas mover, e.g. a blower or fan, which introduces a rotational spin or turbulent flow of the gas entering the first filter housing. For example, a rotational spin of the gas in the first filter housing is suitable for precipitating polar liquids and optionally particles of more than about 1 μm or 500 nm in the gas, e.g. based on the effect of inertia and their larger weight compared to the gas, on the first filter medium which can form or be positioned on the second filter housing. A turbulent gas flow may lead to an increased contact between the gas and the first filter medium to increase the probability of contact of the polar liquid with the first filter medium, where the polar liquid is absorbed.

The device described herein may comprise more than one first filter media, and/or more than one first filter housings which are positioned separate from one another. For example, one first filter medium and/or housing “A” may be specifically designed to retain polar liquids, e.g. due a filter medium with water-absorbing properties mediated by a hydrophilic surface, e.g. a cellulose material or a material with hydrogel fibers, wherein water is first adsorbed, then absorbed and only released in gaseous form by diffusion. A second first filter medium and/or filter housing “B” may be used in the device downstream of the medium and/or housing “A” which can be specifically designed to retain solid particles larger than one 1 μm or 500 nm (e.g. dust, bacteria, spore or pollen).

For example, the first filter housing may comprise any means, e.g. guiding means, vanes, or channels, which force the gas flow to contact the first filter medium.

In another embodiment, the first filter housing comprises a gas outlet configured to straighten the gas flow. The straightening of the gas flow may be achieved by an additional, third filter medium, e.g. with a honeycomb shape, or by the first filter medium forming the gas outlet and having a structure that is suitable for straightening the air flow.

In a further embodiment, the gas outlet of the first filter housing comprises a third filter medium. For example, the third filter medium for straightening the gas flow may also filter larger particles larger than one 1 μm or 500 nm (e.g. for dust, bacteria, spore or pollen filtration) in diameter before the gas reaches the second filter medium.

The relative allocation of the first and second filter housing may be any allocation that allows a gas flow from the first to the second filter housing without any substantial gas leakage between the first and second filter housing.

In another embodiment, the first and the second filter housings are arranged in sequence, for example as shown in FIG. 17.

In a further embodiment, the first filter housing is positioned within the second filter housing, for example as shown in FIGS. 14 to 16.

For example, and for all devices described herein, the first and second filter housing may be detachable from each other. For example, the second filter housing can be exchanged and a new second filter housing can be attached to the first filter housing, e.g. for maintenance purposes.

In another embodiment, the device described herein further comprises a device for moving gas, optionally a radial blower or a fan, configured to move the gas through the device. For example, a radial blower can be used, e.g. with steep pressure characteristics, e.g. a radial blower that provides a pressure level of up to about 25 mbar. For example, the device for moving gas can be positioned before the first filter medium and can push gas onto the first filter medium and/or into the first filter housing. The device for moving gas may also be comprised within the first filter housing, and, e.g., create a rotational spin within the first filter housing. For example, the device for moving gas may be comprised within the first filter housing and its shape may constitute flow-directing means which introduce and/or increase a rotational spin or turbulent flow of the gas within the first filter housing.

In an embodiment, the first filter medium forms an impaction filter. For example, the collision of polar liquids and optionally particles of more than about 1 μm or 500 nm with the material of the first filter medium results in the liquids and particles being retained therein or thereon.

For example, the first filter medium of any embodiment described herein, does not filter and/or retain particles smaller than about 500 nm at a gas velocity in the filter of about >0.5-1 m/s-but retains microparticles >1 μm, optionally >500 nm, and/or absorbs polar liquids and/or polar liquids comprising ultrafine particles and/or particles, e.g. with a size of >500 nm or >1 μm.

In a further embodiment, the first filter medium has a medium pore size of more than about 30 μm, optionally a pore size in the range of 30 to 100 μm, 50 to 100 μm or 30 to 200 μm, is made from fiber-based constructs like fleeces, papers, configured textiles, optionally packed knitted metal fibers, or foams of any material selected from organic, optionally cellulose, hydrophobic fibers, optionally polyolefines, hydrophilic fibers, optionally polyesthers and polyurethanes, and inorganic fibers, optionally steel, aluminum, copper, silver, glass, mullite fibers, sintered metals, optionally steel and aluminum, and ceramic powders, optionally glass and mullite powders, and open porous polymers, optionally polyurethane, polyolefin and polystyrene foams.

The first filter medium of any embodiment herein may have a filter medium thickness of, e.g. about 0.2 to 20 mm. The filter medium thickness is the thickness of the material, i.e. the material strength, the filter is made from. The first filter medium may have a depth of, e.g. about 10 to 300 mm. The depth of the filter medium is the total distance from one side of the filter medium to the opposing side in direction of gas flow.

For example, the second filter medium can be coated with a hydrophobic material on the gas entry side of the medium in order to substantially avoid polar liquid condensation build up. Exemplary hydrophobic coatings are selected from the group consisting of grafted molecules exposing hydrophobic end groups such as, e.g. HF , PVD or CVD deposited hydrophobic Teflon like substances and/or coatings described in Coclite 2013—Super-Hydrophobic and Oloephobic Crystalline Coatings by Initiated Chemical Vapor Deposition, Physics Procedia 46(2013)56-61, or Darband 2020 Science and Engineering of Superhydrophobic Surfaces: Review of Corrosion Resistance, Chemical and Mechanical Stability. Optionally, the coating does not penetrate more than about 15% to 25% of the thickness of the second filter medium.

For example, and in addition or as an alternative to the hydrophobic material, the second filter medium can be coated with a hydrophilic material on the gas exit side of the medium in order to substantially avoid the formation of droplets of polar liquids, e.g. in case some liquid condensation would have penetrated the second filter medium.

Both the hydrophobic and hydrophilic material can be coated on the filter medium either during filtering operation, e.g. by spraying of the hydrophobic substance or during reverse flow from the distal end of the device to the filter medium by hydrophilicity inducing substances.

The second filter housing for any embodiment disclosed herein may also comprise the second filter medium as a honeycomb cell structure with alternately closed cells at the entry and the outlet, e.g. the second filter housing can be substantially made from and filled with the second filter medium, wherein the gas passes through the honeycomb walls of the second filter medium as described by the inventers in the SAE-Paper SAE 2009-01-1087.

The second filter medium may be any filter medium known in the art that is suitable for filtering ultrafine particles as described in Handbuch Verbrennungsmotor by Basshuysen/Springer Vieweg 2017 Chapter 21.6.3.

In another embodiment, the second filter medium forms a diffusion filter.

In another embodiment, the second filter medium has a medium pore size in the range of 10 to 20 μm, optionally 5 to 20 μm, is made from ceramic, metallic, plastic or cellulose materials in form of fiber structures or foams and/or has a filter medium thickness in the range of 0.2 to 5 mm, optionally 0.2 to 1 mm, and/or a filter depth in direction of gas flow of 3 to 10 mm for a pleaded filter medium or 10 to 50 cm for a cell-shaped, e.g. honeycomb, filter medium.

For both, the first and second filter medium, the filter medium thickness is the thickness of the material, i.e. the material strength, the filter is made from. For example, in a cell-type filter, e.g. a honeycomb filter, the filter medium thickness relates to the thickness of the filter material in between the cells. The depth of the filter medium is the total distance from one side of the filter medium to the opposing side in direction of gas flow. For example, the filter depth of a cell-type filter corresponds to the length of the cells of the filter from the one side of the filter medium to the opposing side in direction of gas flow.

The second filter medium can be made from papier mâché, e.g. with cellulose fibers of less than about 1 mm in length. The second filter medium may be suitable for disposal and waste incineration. For example, the second filter medium may feature pores that allow particles, e.g. dust particles, of more than about 1 but smaller than 8 μm to penetrate the second filter medium.

For example, the first and/or second filter medium may be a pleated filter or a cell-type, e.g. honeycomb filter.

For example, the first and/or second filter medium can be exchangeable independent of the first and/or second filter housing.

In a further embodiment, the gas velocity through the first filter housing and/or first filter medium is in the range of 0.5 to 5 m/s, optionally 0.5 to 2 or 0.5 to 1 m/s. This gas velocity generally leads to a collision of polar liquids and optionally particles of more than about 1 μm or 500 nm with the material of the first filter medium and results in the liquids and particles being retained therein or thereon.

The term gas velocity as used herein for the first and second filter medium refers to the velocity of the gas perpendicular to the surface area of the first or second filter medium, i.e. the filter material, through which the gas passes.

For example, the pressure in the first filter housing may be in the range of 1 to 5 mbar and/or the pressure in the second filter housing may be in the range of 5 to 15 mbar. The pressure may be adjusted by the gas moving device (e.g. dimension of the gas moving device, fan or blower speed etc.), the density or porosity of the first and/or second filter medium, the space velocity at the first and/or second filter medium, the shape of the first and/or second filter housing, e.g. including the size of the area through which the gas passes from the first to the second filter housing and/or from the second filter housing to the outside of the device, or by a combination thereof. The term space velocity, as used herein, is defined as the gas volume divided by the filter volume with 1/s as unit.

For example, the gas velocity passing through the first filter medium and/or the first filter housing is higher than the gas velocity passing through the second filter medium and/or housing. The gas mass flow rate, however, is optionally constant through the filter device. For example, the difference in gas velocity between the first and second filter medium and/or housing can be achieved by rendering the volume of the first filter housing smaller than the volume of the second filter housing, e.g. to ensure a gas velocity through the second filter medium which is suitable for filtering ultrafine particles, e.g. as defined herein. Alternatively, the gas velocity may be adjusted to be higher in the first filter medium and/or housing compared to the second filter medium and/or housing (e.g. while keeping the gas mass flow rate essentially constant through the device) by reducing the gas velocity in the second filter medium/housing by increasing the surface area of channels in the second filter medium, e.g. by increasing the length of the passages through which the gas is forced from entry to exit of the second filter medium. The aforementioned reduction of gas velocity is particularly suitable for filter devices in which the first filter and second filter housing are of comparable or essentially similar volume, e.g. if the first and second filter medium are installed in a cylindrical housing which forms both, the first and second filter housing.

In another embodiment, the gas velocity through the second filter medium is in the range of 1 to 100, optionally 1 to 20, 1 to 10 or 1 to 3 cm/s. This gas velocity generally allows the interaction of the ultrafine particles with the surface of the second filter medium based on, e.g. can der Waals forces, and results in the adsorption of the ultrafine particles on the surface of the second filter medium. Generally, the average gas velocity through the first or second filter medium is the average gas velocity through the filtering walls, also termed the face velocity.

For example, the ratio between the gas velocity through the first filter medium and the second filter medium can be about or greater than about 10:1.

For example, the device described herein may comprise heating means for heating the first filter housing and/or first filter medium for supporting evaporation of liquids. For example, heating means can be electrically conducting materials, e.g. metal materials, or hot air heated outside the device.

In another embodiment, at least the surface of the first and/or second filter medium is antimicrobial, antifungal and/or antiviral, optionally is silver or silver-coated.

For example, the first filter medium can be coated with antibacterial and/or antifungal coatings, e.g. silver- and/or copper-comprising coatings.

For example, disinfection of the first filter medium can also be achieved by UV-C irradiation (e.g. with a UV light within the device).

For example, the second filter medium can be coated with antiviral coatings such as, e.g. silver- and/or copper-comprising coatings. The second filter medium may, e.g., also be disinfected during service intervals with e.g., alcohol—(e.g. ethanol or isopropanol) comprising solutions. Also, the second filter medium may be heated for disinfection or it may be disinfection by oxidative regeneration (e.g. in addition to heating). For example, the second filter medium may be detachable from the device described herein and may be autoclaved after removal.

In a further aspect, the present invention is directed to a use of the device as described herein for filtering ultrafine particles from a gas, optionally from a gas comprising polar liquids, optionally water, and optionally particles of more than about 1 μm or 500 nm diameter, e.g. organic particles such as pollen, bacteria, spores from bacteria and fungi) and inorganic (mineral) dust particles.

The polar liquids in the gas, as described herein, are present, e.g. in the form of droplets.

In an embodiment, the use described herein is one, wherein the ultrafine particles are selected from the group consisting of particles with a diameter of 10 to 500 nm, combustion soot particles, metal oxide particles, solid nuclei of any substance, metalloorganic particles, viruses, in particular those which are insoluble in the airway liquids.

In another aspect, the present invention is directed to a kit of parts comprising a device as described herein and optionally instructions for its use.

For example, the kit of parts may also comprise the first and second filter medium and/or the first and second filter housing, as well as, e.g. any other components described herein such as the gas moving device or heating means, separately but configured to be assembled.

In a further aspect, the present invention is directed to a method for filtering ultrafine particles from a gas, optionally a gas comprising polar liquids, optionally a gas comprising liquid water, the method comprising:
(a) providing a device or kit of parts as described herein; and
(b) passing the gas of interest through the device.

The filter device described herein is not only suitable for cleaning air in a given space, it is also suitable for cleaning the exhaled air of a human or animal, for example of a human or animal infected with a microorganism or virus. Above and in the following, the filtering is described with reference to the filter device described herein. However, it is within the scope of this disclosure that any device suitable for filtering ultrafine particles, microorganisms and/or viruses can be used in the systems described herein.

### BRIEF DESCRIPTION OF THE DRAWINGS

In the following, the invention will be described by reference to the figures, none of which are to be interpreted as limiting the scope of the present invention.

FIG. 1 shows an exemplary system for air decontamination in a three-dimensional (3D) space according to the present disclosure.

FIG. 2 shows the substantially laminar flow around persons in the 3D space in an embodiment of the present disclosure.

FIG. 3 shows a specific suction zone or ventilation zone within the 3D space in an embodiment of the present disclosure.

FIG. 4 shows a specific suction zone or ventilation zone created by an embodiment of the system of the present disclosure that creates a 3D space around a person.

FIG. 5 shows an exemplary close-up of the air intake part of the system described herein.

FIG. 6a shows an exemplary close-up of the air intake part of the system described herein.

FIG. 6b shows an exemplary close-up of the air intake part of the system described herein.

FIG. 7a shows an exemplary embodiment of the air outlet of the system described herein.

FIG. 7b shows an exemplary embodiment of the air outlet of the system described herein.

FIG. 7c shows an exemplary embodiment of the air outlet of the system described herein.

FIG. 8a shows a side view of an exemplary system described herein in a 3D space.

FIG. 8b shows the corresponding top view of the same 3D space of FIG. 7a.

FIG. 9a shows a schematic top view of the room for the experimental set up of Example 1.

FIGS. 9b and 9c are photographs showing part of exemplary air outlets.

FIG. 9d shows the arrangement of the nebulizer (round circle) and the 2 sensors (squares, S2 sensors as outlined in the example) used in the example.

FIG. 9e shows the air inlets (transparent cones) arranged at the ceiling.

FIG. 10 shows a 3D uplift zone around a person.

FIG. 11 shows an exemplary system for creating a 3D space around a person.

FIG. 12 shows a further embodiment of the present disclosure for creating a curtain of airflow.

FIG. 13 shows an exemplary system for avoiding infections among people in a given space.

FIG. 14 shows an exemplary filter device according to the present disclosure.

FIG. 15 shows an exemplary filter device according to the present disclosure.

FIG. 16 shows an exemplary embodiment of the filter device.

FIG. 17a shows an exemplary first filter housing.

FIG. 17b shows an alternative embodiment for the second filter housing.

FIG. 17c shows an exemplary first filter housing.

FIG. 18 illustrates an alternative filter device according to the present invention.

### DETAILED DESCRIPTION

In the following, the invention will be described by examples with reference to the figures and examples, none of which are to be interpreted as limiting the scope of the present invention.

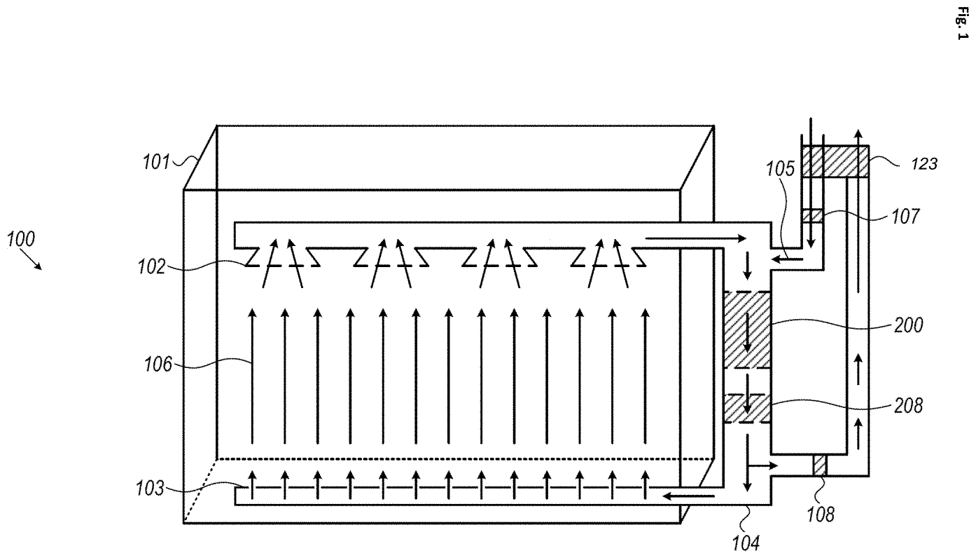

FIG. 1 illustrates a system (100) for air decontamination in a three-dimensional (3D) space (101) according to the present invention. The substantially vertical laminar flow, i.e. the relatively slow and turbulence-free air flow, that effectively channels particle-contaminated air up and away from a person is shown as exemplary arrows (106). The direction of arrows (106) is substantially vertical, from a lower part of the 3D space to the upper part of the 3D space, but the arrows do not realistically reflect the density of the laminar flow. Exemplary average air speeds for the laminar flow (106) are from 0.02 to 0.4 m/s or optionally at most about 0.1 to 0.2 m/s. The air inlet (102) may be of any shape suitable for drawing in air and is not limited to the cones depicted. Also, the number of air inlets is not to be interpreted as being limited by the illustration. An exemplary air speed of the air entering the air inlet (102) at the dotted line is about 0.1 to 0.2 m/s, or about 0.02-0.4 m/s. The air inlets (102) are fluidly connected to a ducting in which the drawn in air is collected and moved (indicated by arrows) towards a filter device (200). Of course, multiple filter devices and multiple sets of tubes ducting the air may be present. Fresh air (105) may be admitted from outside the 3D space, and this can be controlled by a device for regulating the ratio of fresh and filtered air (107), e.g. a gate, flap or valve. The fresh air may or may not be passed through the filter device (200). Air drawn from within the 3D space (101) and preferably passed through the filter device (200) can be partially exhausted to the exterior of the 3D space, e.g. at the control of a similar device (108) described for the admittance of fresh air. A device for moving gas (208), if present, can be positioned before or aft of the filter device (200). For example, any axial, radial or half-radial blower or a fan that pushes or draws air can be used. An optional heat exchanger (123) can be used to exchange heat between the fresh and exhaust air to either heat or cool the fresh air. After passing through the filter device (200), the air (recirculated and filtered air (104) and optionally fresh air (105)) is admitted to the 3D space via the air outlet(s) (103). Only one air outlet is illustrated but the system may comprise multiple air outlets in various positions which may or may not be interconnected. It is emphasized that the air outlets (103) are not necessarily arranged such that they actively “blow” air upwards the air inlets (102) to cause a laminar flow towards the air inlets (102). The air outlets (103) are shown opposite the air inlets (102) for illustration purposes only, but the air outlets do not need to be positioned opposite the air inlets (in vertical direction). Rather, the air outlets (103) but can be positioned anywhere within the 3D space, optionally in the bottom part, as long as their position allows for a substantially vertical laminar flow to occur towards the air inlets, e.g. around a person in the 3D space, which applies to all figures, embodiments and aspects disclosed herein. The air outlets (103) are optionally configured such that the outflowing air assists a substantially vertical laminar flow towards the air inlets (102). The air outlets (103) are optionally positioned at least below the heads of persons in the 3D space, optionally at, on or within the bottom of the 3D space. An exemplary air speed of the air exiting the air outlet (103) at the dotted line is about 0.01 to 0.2 m/s, optionally about 0.05 to 0.15 m/s.

Although the parts of the system that comprise the filter, fresh and exhaust air tubes and corresponding features are shown outside of the 3D space, they can be located anywhere close to or within the 3D space.

FIG. 2 illustrates the substantially laminar flow around persons in the 3D space. These persons may be standing, sitting or lying. The air outlets (103) are optionally positioned at least below the heads of persons in the 3D space, optionally at, on or within the bottom of the 3D space. The description provided for FIG. 1 applies for the remaining features of FIG. 2.

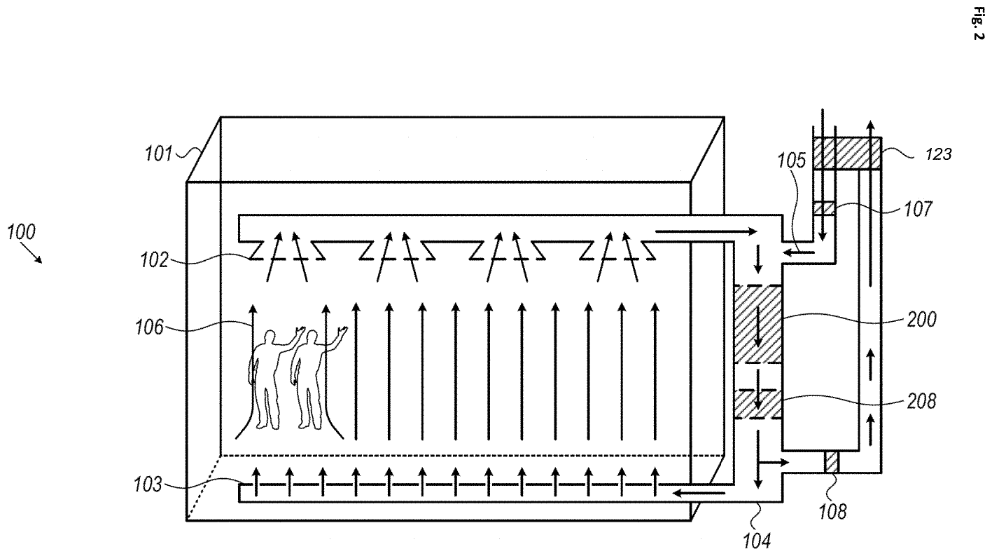

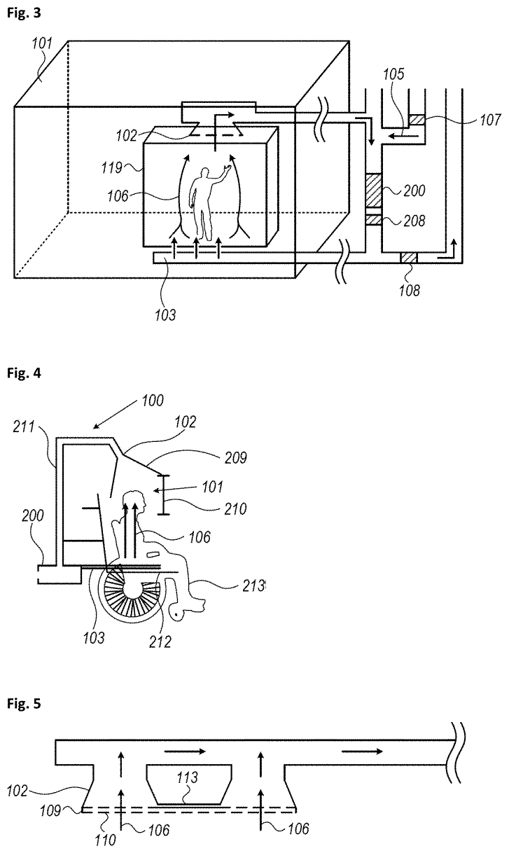

FIG. 3 shows a specific suction zone or ventilation zone (119) within the 3D space (101). In other words, the 3D space (101) is segmented into partial 3D spaces (119) by defining specific suction/ventilation zones. The zone is primarily defined by the position of the air inlet (102) and the location of the person or heated object (heated as described above). Optionally, the air outlet (103) can assist in defining the suction/ventilation zone and the partial 3D space. As noted above for FIG. 1, the air outlets (103) are shown opposite the air inlets (102) for illustration purposes only, but the air outlets do not need to be positioned opposite the air inlets (in vertical direction). Additionally, further structural means such as, e.g., walls, curtains or shields (not shown) can be used to create or define the segmented partial 3D space (119). The person may be standing, sitting on a chair or lying on a bed/sofa or be in any other position. The description provided for FIG. 1 applies for the remaining features of FIG. 3.

FIG. 4 illustrates a specific suction zone or ventilation zone created by a system (100) of the present invention that creates a 3D space (101) around a person (213). The air inlet (102) can form a hood-shaped enclosure (209) that can be placed over a person's head to support the isolating effect of the suction-created laminar flow (106) around the person's head. Connecting means (211), e.g. a tube or hose, can be installed between the air inlet (102)/hood-shaped enclosure (209) and the filter device (200) to allow positioning of the filter device (200) at a convenient location, e.g. attached to a chair, wheelchair or bed. Filtered air is then at least partially passed through the air outlet (103) positioned below the person's head to create the laminar flow (106).

To further support the isolating effect of the uplift zone, a structural barrier (210), e.g. a transparent visor, is optionally positioned in front of the person's mouth and nose to prevent that particles emitted at high velocities (e.g. by sneezing or coughing) penetrate the laminar flow (106). Alternatively or additionally, a face mask can be used for the same purpose.

Depicted in FIG. 4 is a wheelchair (212) but any other seating or laying device is encompassed by this disclosure, e.g. a regular chair, a bed or a hospital bed. The air outlet (103) may include a porous membrane (not shown) and can constitute a cushion of a seat or mattress of a bed. Alternatively, the air outlet (103) may also be positioned in the frame of the bed or chair.

The exhausted and filtered air from filter device (200) can also be partially exhausted away from the person (213).

FIG. 5 illustrates an exemplary close-up of the air intake part of the system (100) described herein. The air inlets (102) (two are shown, but any number is included in the scope of this disclosure) can be attached to one or more perforated members (109) (one shown) including openings (110) through which the air of the laminar air flow (106) is drawn into the air inlet (102). The perforated member (109) (e.g. evenly) distributes the air intake into the air inlets and can also avoid “dead zones”, i.e. areas where air is trapped above an air inlet. The area of the perforated member (109) between the air inlets (102) may be sealed against passing air by sealing means (113). The perforated member (109) may also extend further on the sides beyond the cross section of the air inlet (102) (not shown). For example, the assembly of FIG. 5 may be positioned above a person in a 3D space, e.g. a person sitting at a desk or lying in a bed.

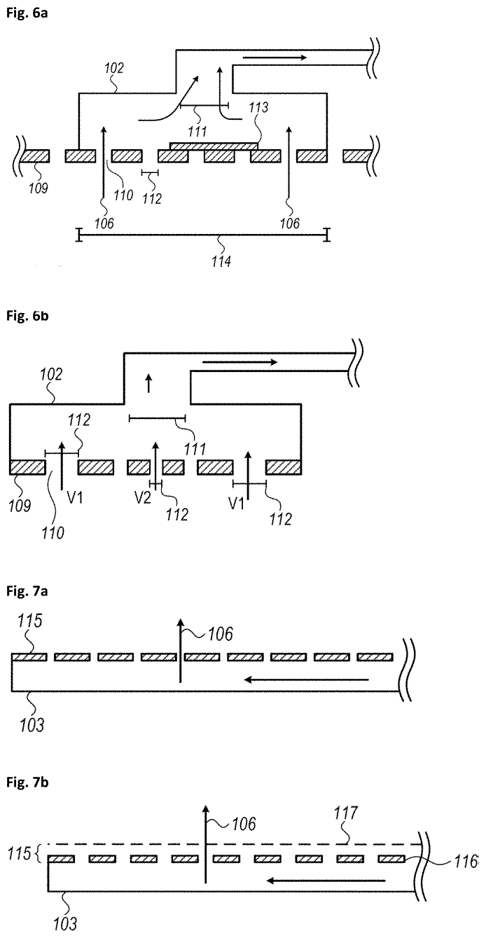

FIG. 6a illustrates an exemplary close-up of the air intake part of the system (100) described herein. For achieving a uniform air suction across the perforated member (109), it is beneficial that the cross section (111) of the air inlet (102) is about the same or larger than the sum of the cross sections (112) of the openings (110) in the perforated member (109). Optionally, a ratio between a sum of a surface (112) defined by the openings (110) and a total surface (114) of the perforated member (109) is about 1:1 to 1:30, optionally about 1:2 to 1:20, optionally about 1:3 to 1:10. In other words, the sum of all distances (112) within the total surface (114) is compared to the total surface (114) of the perforated member. It is noted that the cross sections (112) are of the same size for illustration purposes only, however, these cross sections (112) may and optionally do vary across the perforated member (109) in order to achieve a uniform air suction across the member. Hence, alternatively or additionally, and as shown in FIG. 6b the uniform air suction across the perforated member (109) can be achieved by variation of the size of the cross sections (112) and their distribution across the perforated member (109). For example, the size of the cross sections (112) can be chosen such that the cross sections (112) furthest away from the cross section (111) of the air inlet (102) are larger compared to the cross sections (112) closer to the cross section (111) of the air inlet (102) which are smaller. This size difference of the cross sections (112) at different positions relative to the cross section (111) of the air inlet (102) means that the volume air flow (V2) through a cross section (112) closer to the cross section (111) of the air inlet (102) is essentially the same compared to the volume air flow (V1) through a cross section (112) further away from the cross section (111) of the air inlet (102), i.e. V1 equals about V2.

FIG. 7 illustrates different exemplary embodiments of the air outlet (103) of the system (100) described herein. FIG. 7a shows an air outlet (103) comprising a porous membrane (115) through which the air flows (arrow 106). The porous membrane may be single or multi-layered and made from different or the same materials. FIG. 7b shows an air outlet (103) comprising a porous membrane (115) made from two different components: a structural support layer such as, e.g. a perforated (metal) plate (116) comprising air openings, and a sieve or screen cloth/fabric or mesh laminate layer (117) through which the air passes and the air's velocity is reduced. Further layers as described herein may be comprised in the porous membrane (115) in different orders. FIG. 7c shows an air outlet (103) comprising a porous membrane (115) which itself comprises a foam (body) (118) that is optionally covered by a further layer (117) with sufficient stability as described above, e.g. a sieve or screen cloth/fabric or mesh laminates. Alternatives for the foam (118) include a semi-rigid porous structure such as 3D-spacer fabrics used for cushions or mattresses, e.g. if the air outlet (103) including the porous membrane constitutes a cushion of a seat or mattress of a bed. It is noted that when foams are used, it is advantageous that the porosity of the foam is higher than that of the further layer (117) with sufficient stability as described above to ensure a uniform air flow (106) across the air outlet.

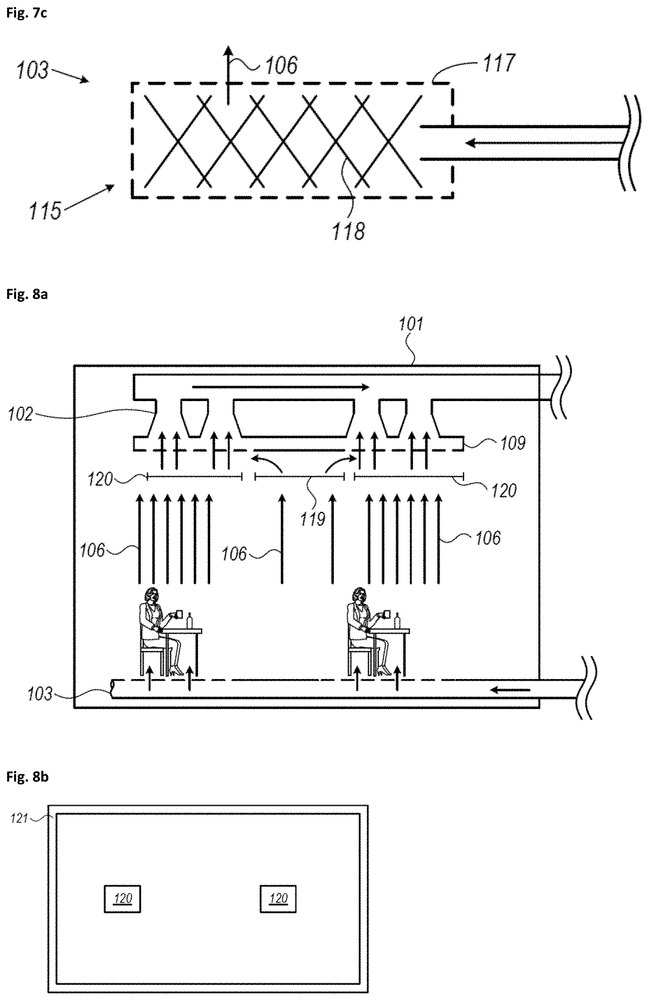

FIG. 8a illustrates a side view of an exemplary system (100) described herein in a 3D space (101), e.g. a classroom, with active ventilation zones (120) where air is drawn into air inlets (102), e.g. through a perforated member (109) which can, e.g. form a ceiling. Alternatively, the air inlets (102) can be arranged to form an active ventilation zone without a perforated member (109) by their arrangement. Passive zones (119) refer to zones where no air passage is granted into the air inlets (102). Optionally, air outlets (103) can be positioned under the active ventilation zones (120) to increase the substantially vertical laminar air flow (106). However, and as noted above for FIG. 1, the air outlets (103) are shown opposite the air inlets (102) for illustration purposes only, but the air outlets do not need to be positioned opposite the air inlets (in vertical direction) and can be positioned, e.g. in the skirting board on the walls of the 3D space (e.g. classroom). FIG. 8b shows the corresponding top view of the same 3D space of FIG. 7a where the active ventilation zones (120) are indicated. Optionally, the system (100) can comprise an alternative or further active ventilation zone (121) around the perimeter of the 3D space which is formed in the same manner as the other ventilation zones (120), e.g. by the presence of air inlets (not shown) in combination with optional perforated members and/or air outlets (not shown) as described herein. The remaining parts of the system described in FIG. 1 are also not shown for simplicity.

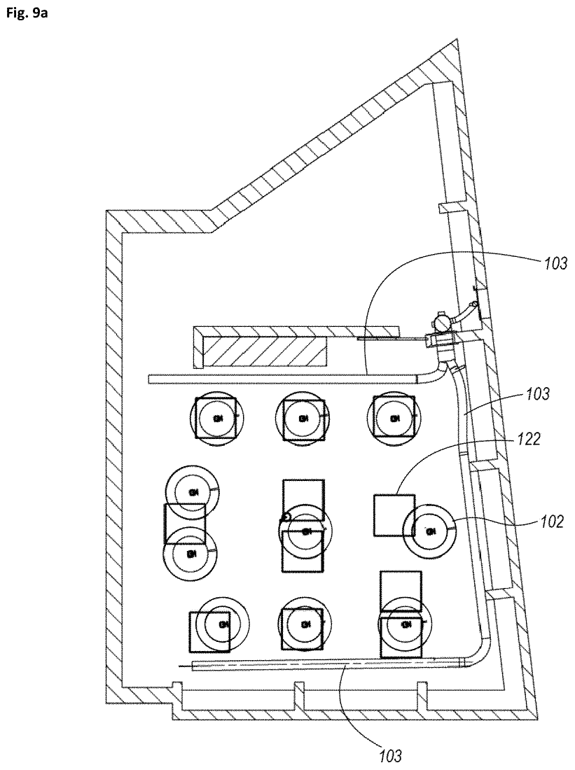

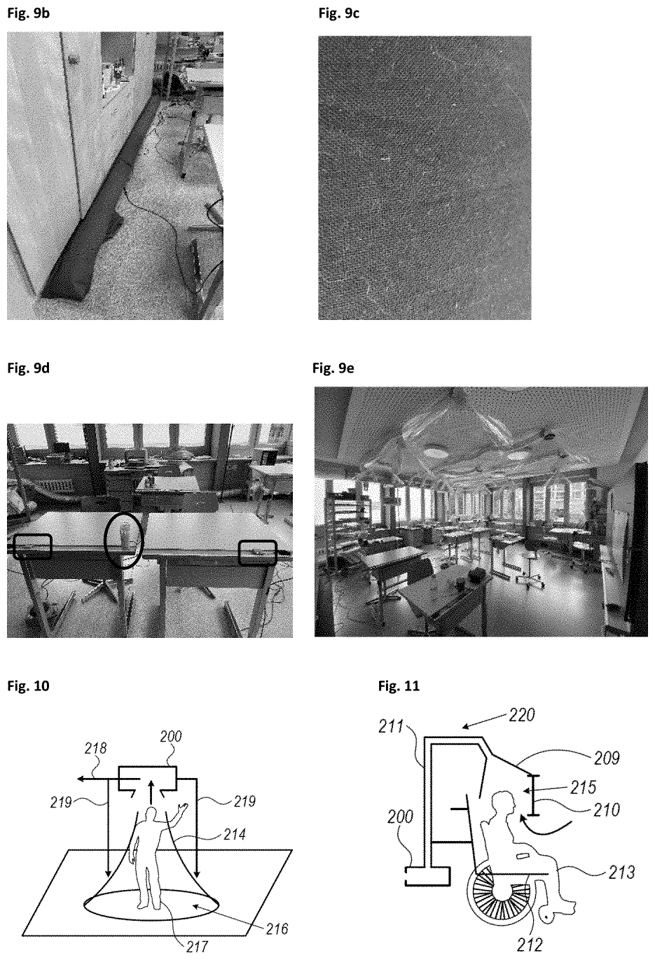

FIG. 9a shows a schematic top view of the room for the experimental set up of Example 1. Shown are the air outlets (103), the air inlets (102) and the desks or tables (122) for people to sit in the room. FIG. 9b is a photograph showing part of the air outlets (103) which comprise a porous membrane made from cotton cloth with a linen binding as shown in FIG. 9c. FIG. 9d shows the arrangement of the nebulizer (round circle) and the 2 sensors (squares, S2 sensors as outlined in the example) used in the example. FIG. 9e shows the air inlets (transparent cones) arranged at the ceiling.

FIG. 10 illustrates the 3D uplift zone (216) around a person (217), optionally an infected person, optionally infected by a virus, which is formed by air flow (214) created by sucking air into a filter device (200) above the person.

In any embodiment and for all aspects, the filter device (200) may be movably positioned above the person (217) and it may follow the movements of the person. For example, a track system or any other mounting system that allows for movable positioning of the filter device (200) can be used above peoples' heads so that the filter device follows the peoples' movements. For example, in cues or workspaces where peoples' movements can be predetermined the filter device(s) follow the movement of the people. Movement or gathering of people where air cleaning is required can be determined, e.g. by monitoring CO₂ emissions in a space of interest and moving the filter devices to the areas of increased CO₂ emissions.

The exhausted and filtered air from the filter device (200) can either be exhausted away from the person (arrow 218) or it can be exhausted around the person creating a curtain of airflow (arrow 219) around the person, wherein the exhausted air is at least partially re-administered to the uplift zone and is recycled in the filter device. The percentage in the volume of air of the curtain of airflow that is re-administered to the uplift zone compared to the volume of air that is not re-administered can be in the range of, e.g. 10 to 40%. Exemplary air speeds for all embodiments, and only with reference to FIG. 10 for easier understanding, can be 0.1 to 0.2 m/s within the uplift zone (216) and/or 0.5 to 5 m/s for the exhausted air (arrow 219) to create the curtain of airflow mentioned above.

In all embodiments, if the filtered air is re-administered, it can be advantageous to include a CO₂ sensor to determine if and what amount of fresh air must be supplied.

FIG. 11 illustrates a system (220) for creating a 3D space (215) around a person (213) and for filtering the air in that space by a filter device (200). A hood-shaped enclosure (209) can be placed over a person's head to support the isolating effect of the suction-created uplift zone around the person's head. Connecting means (211), e.g. a tube or hose, can be installed between the hood-shaped enclosure (209) and the filter device (200) to allow positioning of the filter device (200) at a convenient location, e.g. attached to a chair, wheelchair or bed.

To further support the isolating effect of the uplift zone, a structural barrier (210), e.g. a transparent visor, is positioned in front of the person's mouth and nose to prevent that particles emitted at high velocities (e.g. by sneezing or coughing) penetrate the uplift zone. Alternatively or additionally, a face mask can be used for the same purpose.

Depicted in FIG. 11 is a wheelchair (212) but any other seating or laying device is encompassed by this disclosure. The exhausted and filtered air from filter device (200) can be exhausted away from the person (213), it can be re-administered to 3D space (215), or it can be exhausted around the person creating a curtain of airflow around the person and towards the hood-shaped enclosure, resulting in the effects described above.

Exemplary air speeds for all embodiments, and only with reference to FIG. 11 for easier understanding, can be 0.1 to 0.2 m/s within the hood-shaped enclosure (209) and/or 0.5 to 5 m/s for the exhausted air to create the curtain of airflow mentioned above.

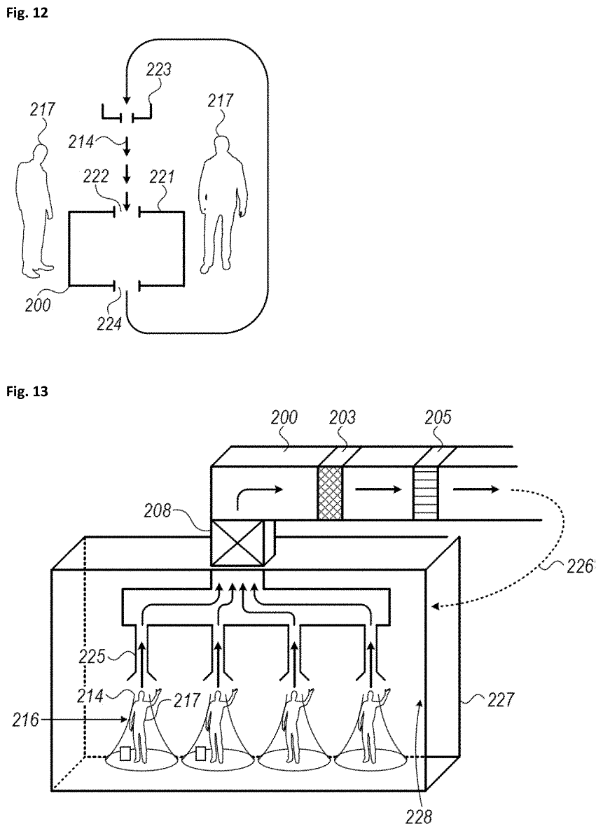

FIG. 12 illustrates a further embodiment of the present disclosure for creating a curtain of airflow and optionally concomitantly filtering ultrafine particles from the said airflow. For example, a curtain of airflow (214) can be created between two people (217), e.g. between an infected and non-infected person, which are positioned opposite each other at a table, desk or counter (221). The table, desk or counter (221) comprises an aperture (222), and an outlet (224) which is in fluid and air-tight communication with a second outlet (223) positioned above the table, desk or counter (221). Air is sucked into the aperture (222) and is optionally filtered by a filter device positioned in the table, desk or counter (221), in the second outlet (223) or anywhere in between these structures. The optionally filtered air is then at least partly released through second outlet (223) creating a curtain of airflow that separates the people (217) and avoids exchange of potentially contaminated exhaled air between the people (217). Additionally, part of the filtered air may also be released towards the people (217) standing at the table, desk or counter (221), which creates an additional airflow that further avoids mixing of exhaled air of the two people (217).

FIG. 13 illustrates a system for avoiding infections among people (217) in a given space (228), e.g. a working or production building (227), and for filtering air drawn from the building (227). Air is drawn up from above a person (217) creating an uplift zone (216) by the airflow around the person (214). The air is drawn up, for example, at speeds of about 0.1 to 0.2 m/s when measured above a person's head. A gas moving device (208), e.g. a ventilator, moves the air (arrows) into a filter device (200) as described herein. In the filter device (200), here, for example a tubular or rectangular elongated device of an essentially constant cross section or diameter, the air is first passed through the first filter medium (203) acting as an impaction filter, e.g. at velocities between about 0.5 and 5 m/s in order to filter and retain polar liquids and optionally particles of more than about 1 μm or 500 nm on or within the material of the first filter medium (203) after the collision of polar liquids and optionally particles with the first filter medium (203). Subsequently, the air moves towards and through the second filter medium (205) acting as filter at an air velocity of about 0.01 to 0.1 m/s, i.e. a reduced velocity in order to filter ultrafine particles such as viruses in the second filter medium (205). The second filter medium's shape and/or composition, e.g. tubes with alternating outlets (honeycomb) as described herein or any other known ultrafine particle filter, results in the reduction of the air velocity (based, e.g. on the large surface area of the tubes of the filter medium) while the air mass flow remains essentially constant through the filter device (200). The filtered air may then be re-administered to the internal space (208), see arrow (226).

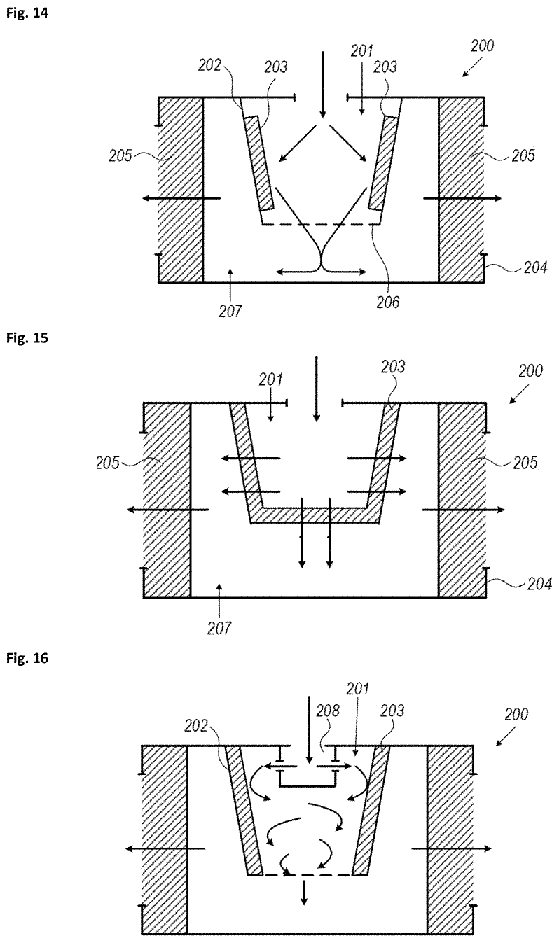

FIG. 14 shows an exemplary filter device (200) according to the present invention. The first filter housing (202) forms a cavity (201) into which the gas enters (arrows refer to gas flow). For all embodiments, the shape of the first filter housing (202) can be any shape that is suitable for forming a housing. It may be of a box or tube shape and it may be tapered as shown in FIG. 14 or feature substantially parallel sides.

In some embodiments, the cavity (201) may comprise means for directing the gas flow towards the first filter medium (203) in order to ensure that polar liquids and/or particles (between 500 and 1000 nm diameter) as described herein come into contact with the first filter medium (203) and are, e.g., absorbed thereon or therein.

For example, the first filter housing may comprise a gas inlet and a gas exit either opposite each other or at any other relative positions in the first filter housing (202). The size of the gas inlet and outlet in FIG. 14 is non-limiting and may be adjusted by the skilled person, e.g. according to the desired air flow and/or size of the filter media.

The first filter housing (202) is partially covered with the first filter medium (203). The gas exits the first filter housing (202) via an opening (206) which may optionally also comprise a third filter medium as described herein which may, e.g. additionally straighten the gas flow and/or filter particles (e.g. between 500 and 1000 nm diameter) as described herein. The gas enters the second filter housing (204) which forms a cavity (207) and may, in some embodiments, be of any shape, e.g. a box or a cylinder. The second filter medium (205) partially forms the filter housing at the gas exit. In some embodiments, the second filter medium (205) can also completely form the filter housing.

FIG. 15 illustrates an exemplary filter device (200) according to the present invention, wherein the first filter medium (203) forms the first filter housing and the gas exits the first filter housing via the first filter medium (203) in direction of the second filter housing (204). Substantially all the gas to be filtered passes through the first filter medium (203) when moving into the second filter housing (204). Again, the second filter medium (205) can, e.g., also completely form the second filter housing (204).

FIG. 16 shows an embodiment of the filter device (200), wherein the first filter medium (203) either partially forms the first filter housing (202) or covers the first filter housing (202) on the side of the cavity (201). A gas moving device (208), e.g. a radial blower or any other gas moving device described herein, moves the gas and creates a rotational spin (circling arrows) within the first filter housing (202). For example, the shape of the gas moving device (208) may constitute flow-directing means which introduce and/or increase a rotational spin or turbulent flow of the gas within the first filter housing, for example also independent of the type of the gas moving device.

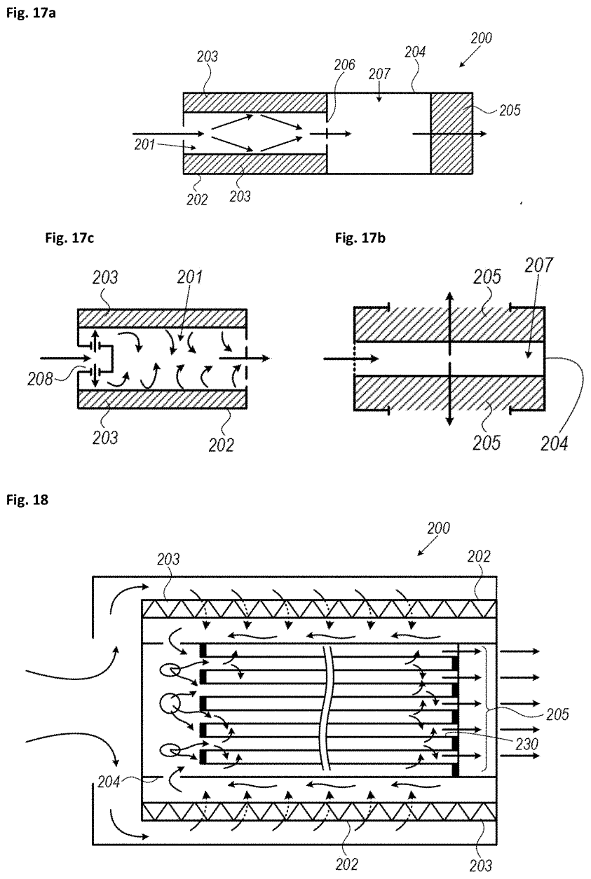

FIG. 17 illustrates exemplary embodiments of the filter device (200), wherein the first filter housing (202) and the second filter housing (204) are arranged in series. Each of the first and second filter housings of FIGS. 17a to 17c may be combined with each other. For example, and for all devices described herein, the first and second filter housings (202 and 204) may be detachably connected.

FIG. 17a illustrates a first filter housing (202), wherein the first filter housing (202) is partially covered with the first filter medium (203).

For example and for all embodiments, the first filter housing (203) can be gas-tight at the area of contact with the first filter medium (203) in order to move substantially all gas from the first filter housing (202) to the second filter housing (204).

The gas exits the first filter housing (202) via an opening (206) which may optionally also comprise a third filter medium as described herein which may, e.g., additionally straighten the gas flow.

As for all devices disclosed herein, a gas moving device may be positioned at the air inlet of the first filter housing (e.g. where the arrow shows entry of the gas into the device in FIG. 17a) or within the first filter housing (202).

For example, the first filter housing (202), i.e. the cavity (201) of all embodiments may be shaped or may comprise means for directing the gas flow towards the first filter medium (203) in order to ensure that polar liquids come into contact with the first filter medium (203) and are, e.g., absorbed thereon or therein.

The second filter housing (204) may comprise the second filter medium (205) at the site of gas exit, e.g. so that a cavity (207) is formed in between the fist filter housing gas exit and the second filter medium (205), wherein the volume of the cavity (207) and/or the surface area of the second filter medium may be adjusted depending on the required gas velocity/velocities.

FIG. 17b shows an alternative embodiment for the second filter housing (204), wherein the second filter medium (205) partially forms the second filter housing (204). The second filter housing (204) for any embodiment disclosed herein may also comprise the second filter medium (205) as a honeycomb structure. For example, the cavity (207) within the second filter housing (204) may be substantially completely filled with the second filter medium (205), for example in the form of a honeycomb cell filter with alternately closed cell openings (see, e.g. U.S. Pat. No. 4,276,071 A). The gas may then exit the second filter housing (204) on the housing side opposite to the site of gas entry (see, e.g. FIG. 17a) or through the sides of the second filter housing (see, e.g. FIG. 17b).

FIG. 17c illustrates a first filter housing, wherein the first filter medium (203) at least partially covers the first filter housing (202) on the side of the cavity (201). The first filter housing (203) can be gas-tight at the area of contact with the first filter medium (203) in order to move substantially all gas from the first filter housing (202) to the second filter housing (204).

A gas moving device (208), e.g. a radial blower, moves the gas and creates a rotational spin (circling arrows) within the first filter housing (202). For example, the shape of the gas moving device (208) may constitute flow-directing means which introduce and/or increase a rotational spin or turbulent flow of the gas within the first filter housing, for example also independent of the type of the gas moving device.

FIG. 18 illustrates an alternative filter device (200) according to the present invention. The second filter medium (205) is positioned in the center of the device (200). The second filter medium (205) may form the second filter housing (104) or an additional housing may be used. The first filter housing (202) is defined by the circumference of the second filter medium or housing (205, 204) and an outer hull. A gas enters the first filter housing (202) (see arrows) and passes through the first filter medium (203) before entering the second filter (205) or housing (204), e.g. through apertures (229) in the housing. The second filter medium (205) may be of a cell filter-type in which the gas is forced to cross the filter walls from one to another channel (230) before exiting the filter and filter device (200). The filter device illustrated in FIG. 18 may be of a tubular shape, e.g. in which the first filter medium (203) has a ring form and is circumferentially positioned around the second filter medium (205), wherein the gas flows through the first filter medium (203) in a substantially radial direction, and through the second filter medium (205) in a substantially axial direction, which allows for a very compact shape of the filter device (e.g. for use in airplanes, buses, cars or trains). Alternatively, the filter device (200) may be of a planar form comprising two or more discrete first filter elements (203).

### Example 1: Experimental Validation of a System According to the Present Invention

A system according to the present invention was installed in a closed room as depicted in FIG. 9. The room had 60 m² and a volume of 200 m³ with 11 desks distributed according to FIG. 9. The room also featured a water/air heat exchanger of the building heating system on the side walls. A filter device with the following features and properties was used: ceramic cell filter, diameter of 300 mm, 200 cells per inch², pressure loss of 600 Pa at an air passage of 800 m³/h, degree of filtration for particles between 10-500 nm diameter: >99.9%, half-radial blower with a capacity of 800 m³/h, fresh air admittance to the filter at 80 m³/h. The air outlets were in the form of 2 tubes (see FIG. 9) with a length of 500 cm and a flow cross section of 100 cm². The air outlets (tubes) comprised, i.e. were covered with, a porous membrane made from cotton cloth (150 g/m²) and a linen binding (50-500 μm porosity) through which the filtered air was admitted into the room. The air outlets were positioned essentially on the ground of the room on three sides of the room (analogous to a skirting board). The average velocity of the filtered air exiting the air outlets was set at 0.08 m/s. The air inlets were cone-shaped with a diameter of 100 cm at an angle of 90°. The coned openings of the air inlets were positioned about 1 m above the heads of people when sitting in the room. The average air velocity within the tubing connected to the air inlets was set to about 1.2 to 2 m/s which resulted in an average air velocity at the air inlets (at the lower edge of the cone) of about 0.05 to 0.2 m/s. To simulate an aerosol source (e.g. a source of contamination, e.g. viral particles emitted from a person), a nebulizer emitting a 3% NaCl-solution was used. The particle size of the dried solution was 20-25 nm. The nebulizer was positioned on a table in the room at the height of a person's face. A mobile sensor S1 (Partector, naneos particle solutions GmbH, Windisch, Switzerland) was used for detecting ultrafine particles (particles between 10 and 500 nm). On each of the tables a sensor S2 (Sensirion, Stäfa, Switzerland) was positioned to measure visible particles (measuring particles larger than 300 nm by laser diffraction). The particle concentrations and particle sizes at all tables and at the air inlets and outlets in the room were recorded simultaneously at 1 Hz. The pressures before and after the filter were measured and the air throughput was found to be proportional to the pressure loss with a laminar flow across the filter walls at 1-3 cm/s. The CO₂ concentrations were measured and the substantially vertical laminar flow from the ground to the air inlets was confirmed by fume movements (Draeger-Tubes with H₂SO₄).

### Example 2 Results with the Set-Up of Example 1

All measurements were conducted with all tables occupied by people and at a ventilation power of 60% and without any people in the room with a ventilation power of 100%.

### Example 2a: Lateral Cross Contamination at 60% Ventilation Power and Full Occupancy

Lateral cross contamination is used as a model for infection. All tables were occupied by persons. The initial visible particle (larger than 300 nm) concentration in the room was set at 100-200 particles/cc at the onset of the experiment (verified by sensor S2) and the initial ultrafine particle (size between 10 and 500 nm) concentration was set at 2000 particles/cc (verified by sensor S1). The nebulizer was set to emit an average of about 500′000 ultrafine particles/cc (verified by sensor S1) at the perimeter of the cloud with peak particle concentrations of 5 mio/cc. The S2 sensors fixed on the tables to the right and left of the nebulizer detected 5000-6000 visible particles larger than 300 nm per cc at the same time at 0.6 m distance from the nebulizer while the S1 sensor detected up to 50′000 ultrafine particles/cc. The average visible particle concentration detected at those S2 sensors further away than the S2 sensors left and right of the nebulizer stabilized at about 100-1000 particles/cc after 20 minutes, while the ultrafine particle concentration detected with the S1 sensor stabilized at around 10′000 particles/cc. In conclusion, the system reduced the particle load in direct proximity to the source (nebulizer) by >95% and within the whole room by >98%. Example 2b: lateral cross contamination at 100% ventilation power at zero occupancy

Example 2a was repeated without any persons at the tables or in the room and at 100% ventilation power. The same results were obtained compared to Example 2a. In other words, the lack of thermal radiation from persons to support the essentially laminar flow in the room could be compensated by increasing ventilation power.

### Example 2c: Decontamination at 60% Ventilation Power with Moving Persons

Example 2a was repeated but the persons previously seated at their tables continuously and quickly moved/walked within the room. Instead of the nebulizer, an E-cigarette was used to introduce a particle concentration of about 5000 particles/cc measured by sensor S2 (visible particles, >300 nm). After about 5 min at 60% ventilation power, the particle concentration was reduced by 50% as detected by all S2 sensors on 10 tables in the room. After 15 mins, the particle concentration was reduced by 80% as detected by all sensors in the room.

### Example 2d: Filter Efficiency

Filter efficiency was determined by measuring the ultrafine particle concentration in the air admitted through the air inlets with sensor S1 starting from 10′000 particles/cc in the room. No visible or UFP particles could be detected in the air admitted through the air inlets which indicates that less than 200 particles/cc were present in the filtered air (detection threshold of the sensor S1 (Partector device)).

1. A system for air decontamination in a three-dimensional (3D) space, the system comprising
(I) at least one air inlet positioned essentially at a top of the 3D space and configured to draw in air from the 3D space,
(II) at least one air outlet configured to administer filtered and optionally fresh air to the 3D space,
(III) a filter device in fluid communication with the at least one air inlet and outlet, configured to filter ultrafine particles from the air drawn in through the air inlet, and configured to at least partially exhaust the filtered air through the air outlet,
wherein the system is configured to draw air in a substantially vertical laminar flow substantially from a ground of the 3D space, into the air inlet.

2. The system according to claim 1, wherein the 3D space is a closed indoor space, the at least one air inlet is positioned essentially above a height of a standing or sitting person or essentially at a ceiling of the space, and the at least one air outlet is positioned essentially below the height of the standing or sitting person or on the ground of the 3D space.

3. The system according to claim 1, wherein the substantially vertical laminar flow has an average speed of about 0.1 to 0.2 m/s or 0.02 to 0.4 m/s.

4. The system according to claim 1, wherein the system is configured to exchange the volume of the 3D space between 2 to 6 times per hour.

5. The system according to claim 1, wherein the system is configured to have an average air speed of about 0.1 to 0.2 m/s or about 0.05 to 0.2 m/s at the at least one air inlet.

6. The system according to claim 1, wherein the system is configured to have an average air speed of about 0.01 to 0.2 m/s at the at least one air outlet.

7. The system according to claim 1, wherein
the at least one air inlet comprises a perforated member at least partially covering one or more air inlet(s) and having openings through which the air is drawn from the 3D space,
the at least one air inlet comprises a perforated member configured to distribute the air intake and to avoid areas where air is trapped above the air inlet,
the at least one air inlet comprises a perforated member which forms an essentially horizontal, an essentially flat plane, or both an essentially horizontal and flat plane configured to draw air homogeneously over the whole surface of the perforated member, or
a combination thereof.

8. (canceled)

9. The system according to claim 7, wherein the perforated member forms a ceiling of the 3D space.

10. The system according to claim 1, wherein the at least one air outlet comprises a porous membrane through which the filtered air is administered to the 3D space.

11. The system according to claim 10, wherein the porous membrane is configured to reduce a velocity of the filtered air upon administration to the 3D space by a factor of about 50 to 200.

12. The system according to claim 10, wherein the porous membrane has
(a) a porosity of about 40 to 90%;
(b) a pore size of about 0.01 to 1 mm;
(c) a thickness of about 0.1 to 2 mm;
(d) a density of about 100 to 200 g/m²; or
(e) a combination thereof.

13. The system according to claim 10, wherein the porous membrane comprises or is made of a fabric, a cloth, a foam, a perforated plate or a combination thereof.

14. The system according to claim 1, further comprising at least one of:
a device for moving gas,
at least one device for regulating the ratio of fresh and filtered air,
a CO₂-measuring device,
a heat exchanger configured to exchange heat between filtered and fresh air, or
means for thermally supporting, increasing, or supporting and increasing the substantially vertical laminar flow.

15. The system according to claim 14, wherein the system comprises means for warming the filtered air, the fresh air, or both the filtered air and the fresh air, prior to, during or after administration to the 3D space.

16. The system according to claim 15, wherein the means for warming the filtered air, fresh air, or both the filtered air and fresh air, warm the air by about 5 to 20° C. above the temperature in the 3D space.

17. The system (according to claim 1, wherein the 3D space is at least one of a space formed around a person or is further defined by structural means.

18. The system according to claim 1, wherein the 3D space (101) is a space formed around a person standing or sitting in a room, or around a person or around a person's head, lying on a bed.

19. A filter device for filtering ultrafine particles from a gas, the filter device being a second filter medium for absorbing ultrafine particles,
wherein the second filter medium is a cell-type filter medium having a gas entry and exit side and is
(a) coated with a hydrophobic material on the gas entry side, or
(b) coated with a hydrophilic material on the gas exit side.

20. The filter device according to claim 19, wherein the cell-type filter medium is coated with (i) a silver-comprising coating, (ii) copper-comprising coating, or (iii) both (i) and (ii).

21. (canceled)

22. (canceled)

23. (canceled)

24. (canceled)

25. (canceled)

26. (canceled)

27. (canceled)

28. The system for air decontamination in a three-dimensional (3D) space according to claim 1, wherein the filter device comprises a cell-type filter medium for absorbing ultrafine particles, wherein the cell-type filter medium has a gas entry and exit side and is
(a) coated with a hydrophobic material on the gas entry side, or
(b) coated with a hydrophilic material on the gas exit side.

29. (canceled)

30. (canceled)

31. A method for air decontamination in a three-dimensional (3D) space, the method comprising:
(a) providing or installing a system according to claim 1; and
(b) drawing air in a substantially vertical laminar flow substantially from a ground of the 3D space into the air inlet of the system.

32. The system according to claim 1, wherein the at least one air outlet is (i) positioned essentially at the ground of the 3D space, (ii) the filter device is further configured to filter ultrafine particles from fresh air, or (iii) both (i) and (ii).

33. The system according to claim 17, wherein the structural means are curtains, shields, or a hood-shaped enclosure.

34. The method according to claim 31, wherein the 3D space is a medical facility or a space, room, bed, or seat in a medical facility.
